(19) United States
(12) Patent Application Publication
(10) Pub. No.: US 2026/0219965 A1
(43) Pub. Date: Jul. 30, 2026

(54) INFORMATION PROCESSING APPARATUS, METHOD, AND COMPUTER-READABLE RECORDING MEDIUM STORING A PROGRAM THAT CAUSES THE INFORMATION PROCESSING APPARATUS TO EXECUTE A PROCESS

(71) Applicant: KABUSHIKI KAISHA TOSHIBA, Kawasaki-shi (JP)

(72) Inventors: Nayuko WATANABE, Kawasaki Kanagawa (JP); Atsushi KAWASAKI, Yokohama Kanagawa (JP); Tomoki WATANABE, Inagi Tokyo (JP)

(73) Assignee: KABUSHIKI KAISHA TOSHIBA, Kawasaki-shi (JP)

(21) Appl. No.: 19/441,961

(22) Filed: Jan. 7, 2026

(30) Foreign Application Priority Data
Jan. 29, 2025 (JP) 2025-012609

(51) Int. Cl. G06F 9/54

(52) U.S. Cl. CPC G06F 9/54

(57) ABSTRACT

According to one embodiment, an information processing apparatus includes an acquisition unit that acquires a request, a planning unit that generates one or a plurality of process workflows based on the request, an instruction generation unit that generates one or a plurality of data generation instructions for the process workflow generated based on the request, a data generation unit that selects one input data generation method from a plurality of input data generation methods based on the data generation instruction and generates input data, an execution unit that executes the process workflow and outputs an execution result, and a display control unit that displays the input data, the execution result, and the process workflow on a display unit in association with each other.

### CROSS-REFERENCE TO RELATED APPLICATION(S)

This application is based upon and claims the benefit of priority from Japanese Patent Application No. 2025-012609, filed Jan. 29, 2025, the entire contents of which are incorporated herein by reference.

### FIELD

Embodiments described herein relate generally to an information processing apparatus, a method, and a computer-readable recording medium storing a program that causes the information processing apparatus to execute a process.

### BACKGROUND

In order to realize an input data generation method for a process workflow in which, for example, APIs are combined, based on a request sentence input by a general user who is not an expert such as a programmer, it is desired to develop an information processing apparatus, method, and program that automatically generate input data and display an output result based on the input data together with the request sentence of the user.

### BRIEF DESCRIPTION OF THE DRAWINGS

FIG. 1 is a block diagram of an information processing apparatus according to a first embodiment.

FIG. 2 is an example illustrating API information stored in a storage unit of the information processing apparatus according to the first embodiment.

FIG. 3 is an example of a prompt template to the LLM of the information processing apparatus according to the first embodiment.

FIG. 4 is a schematic diagram illustrating a functional configuration of an instruction generation unit of the information processing apparatus according to the first embodiment.

FIG. 5 is a schematic diagram illustrating a functional configuration of a data generation unit of the information processing apparatus according to the first embodiment.

FIG. 6 is a schematic diagram showing a display example of the information processing apparatus according to the first embodiment.

FIG. 7 is a flowchart showing the overall processing of the information processing apparatus according to the first embodiment.

FIG. 8 is a schematic diagram illustrating an acquisition unit of the information processing apparatus according to the first embodiment.

FIG. 9A is a schematic view illustrating process flow information of the information processing apparatus according to the first embodiment.

FIG. 9B is a schematic view illustrating process flow information of the information processing apparatus according to the first embodiment.

FIG. 10A is a schematic view illustrating a result of generating the API execution sequence information of the information processing apparatus according to the first embodiment.

FIG. 10B is a schematic view illustrating a result of generating the API execution sequence information of the information processing apparatus according to the first embodiment.

FIG. 11 is an illustration of a source code of the information processing apparatus according to the first embodiment.

FIG. 12 is a schematic view illustrating conversion of an I/O type of API of the information processing apparatus according to the first embodiment.

FIG. 13 is a schematic diagram showing a prompt editing of input data of the information processing apparatus according to the first embodiment.

FIG. 14 is a flowchart showing a process of generating input data of the information processing apparatus according to the first embodiment.

FIG. 15 is an example of an audio generation instruction of the information processing apparatus according to the first embodiment.

FIG. 16 is a flowchart showing an audio generation process of the information processing apparatus according to the first embodiment.

FIG. 17 is an example of an image list generation instruction of the information processing apparatus according to the first embodiment.

FIG. 18 is a flowchart showing an image list generation process of the information processing apparatus according to the first embodiment.

FIG. 19 is an example of a prompt for instruction generation of the information processing apparatus according to the first embodiment.

FIG. 20 is a block diagram showing a functional configuration of an information processing apparatus according to a second embodiment.

FIG. 21 is a flowchart showing the overall processing of the information processing apparatus according to the second embodiment.

FIG. 22 is a schematic diagram illustrating an example of merging API execution sequence information of the information processing apparatus according to the first embodiment.

### DETAILED DESCRIPTION

In general, according to an aspect of the invention, there is provided an information processing apparatus which includes an acquisition unit configured to acquire a request,

a planning unit configured to generate one or more process workflows based on the request, an instruction generation unit configured to generate one or a plurality of data generation instructions for the process workflow generated based on the request, a data generation unit configured to select one input data generation method from a plurality of input data generation methods based on the data generation instruction, and generate input data, an execution unit configured to execute the process workflow using the input data as input data and output an execution result, and a display control unit configured to cause a display unit to display the input data, the execution result, and the process workflow in association with each other.

Hereinafter, embodiments of the present invention will be described with reference to the drawings. The drawings are schematic or conceptual, and the relationship between the thickness and width of each portion, the ratio of the sizes between portions, and the like are not necessarily the same as the actual ones. Even when the same portion is illustrated, the dimensions and ratios may be illustrated differently depending on the drawings. In the specification and the drawings, the same reference numerals are given to the same elements as those described above with reference to the drawings that have already been referred to, and detailed description thereof will be omitted as appropriate.

### First Embodiment

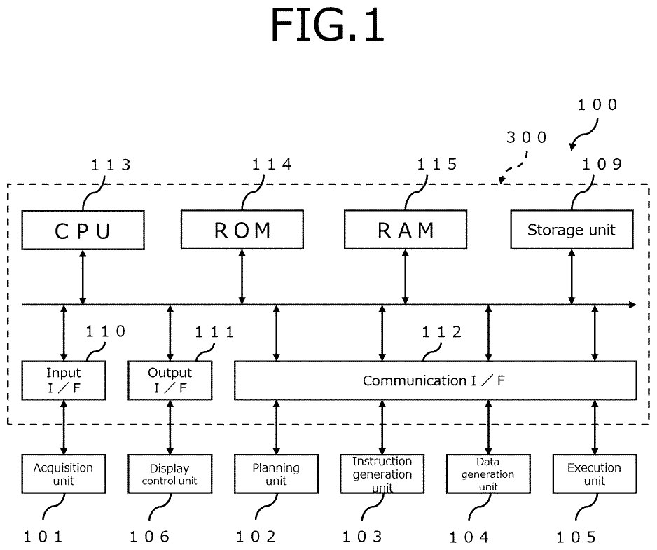

FIG. 1 is a block diagram illustrating a functional configuration of an information processing apparatus according to a first embodiment. As illustrated in FIG. 1, an information processing apparatus 100 according to the first embodiment includes an acquisition unit 101, a planning unit 102, an instruction generation unit 103, a data generation unit 104, an execution unit 105, a display control unit 106, and a processing device 300. The processing device 300 includes an input interface 110, an output interface 111, a communication interface 112, a CPU 113, a ROM 114, a RAM 115, and a storage unit 109.

The acquisition unit 101 acquires a request of the user as a request sentence in the form of text. The request sentence is a sentence written for a use case considered by the user. This may be described in a plurality of sentences or in one sentence. Here, the purpose that the user wants to execute refers to a purpose of executing the request sentence. The request sentence acquired by the acquisition unit 101 is sent to the planning unit 102. The acquisition unit 101 includes one or more selected from a mouse, a keyboard, a microphone (sound input), and a touch panel.

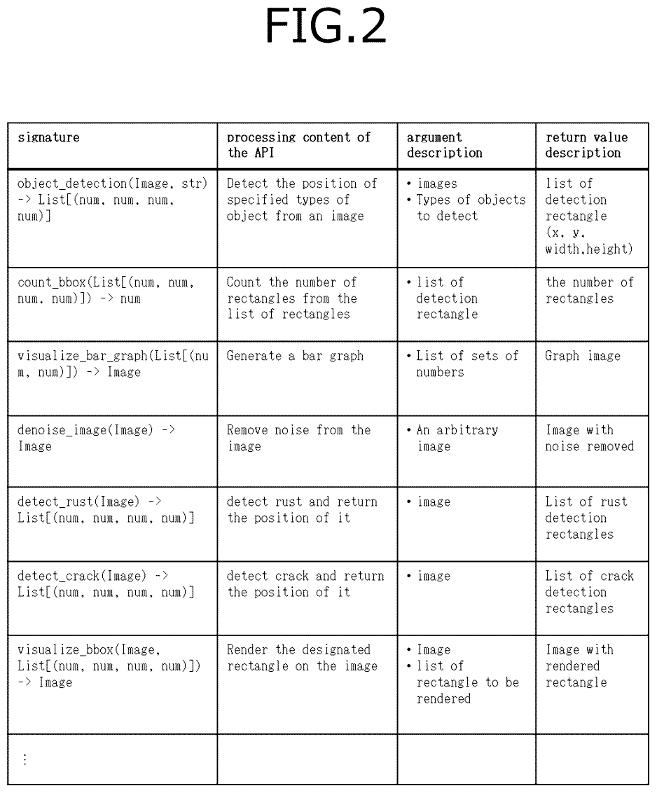

The storage unit 109 holds information of an API that can be used in a process workflow generated by the planning unit 102 described later. FIG. 2 is a table illustrating API information stored by a storage unit of the information processing apparatus according to the first embodiment. It is considered that the API information is stored in the storage unit 109 in a form of a combination of a signature (a combination of a name of a function or a method, the number of arguments, a data type, a type of a return value, and the like), a description for explaining the processing content of the API, a description of the argument, and a description of the return value. In addition, the API can be called based on the signature. In the present embodiment, the storage unit 109 includes one or more selected from a hard disk drive (HDD) and a solid state drive (SSD). In the present embodiment, the storage unit 109 is held in a general relational database (RDB). The RDB may organize data in a table format and express each data by rows and columns. However, the way of holding the API information is not limited to this, and the API information may be held in the form of information described in a file, or may be searched from an API information list on the Web as needed. Examples of the API information list on the Web include a service in which Restful Web APIs of various services are collected, a list of usable machine learning models such as Hugging Face, and the like.

The planning unit 102 generates a source code using the API held in the storage unit 109 based on the request sentence acquired by the acquisition unit 101, and generates an executable process workflow from the source code. The process workflow refers to a plan for executing the request sentence. The data or the object to be processed in the process workflow refers to an object to be controlled in order to execute the request sentence. The process workflow includes process flow information and a format of input data. The process flow information indicates the flow of the process workflow. The executable process workflow corresponds to the source code and is held as API execution sequence information used in the source code. The input data refers to one or more pieces of input data that are candidates to be input to the information processing apparatus by the user. The planning unit 102 generates the API execution sequence information after generating the process workflow. The API execution sequence information indicates the flow of the process workflow, and the API corresponding to the process workflow is displayed. The generated API execution sequence information is stored in the storage unit 109.

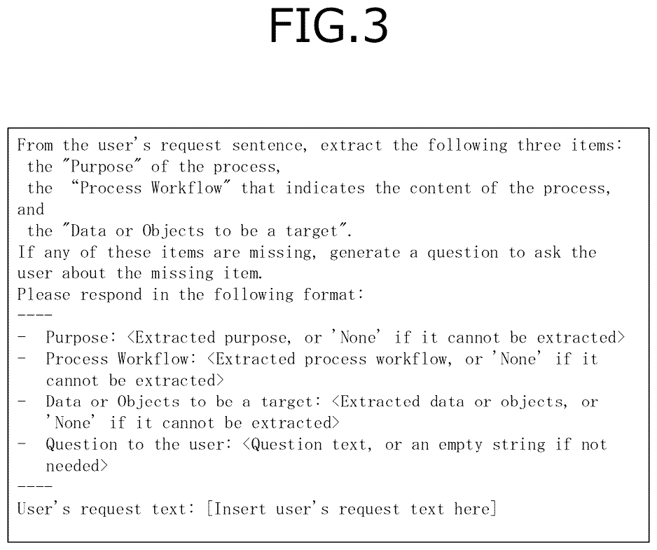

FIG. 3 is an example of a prompt template to an LLM of the information processing apparatus according to the first embodiment. The executable process workflow is considered to hold the format of input data that is the input of the source code. The generated executable process workflow is sent to the instruction generation unit 103.

The instruction generation unit 103 outputs a instructional sentence (prompt) to be input to the generation model used by the data generation unit 104 and an input data generation method for data generation as a data generation instruction in accordance with the request sentence, the format of the input data, the API execution sequence information, and the process workflow to be used. Here, the input data generation method for data generation refers to a processing method performed by the data generation unit 104 that can be switched according to the format of the input data. The data generation unit 104 will be described later. The input data generation method includes information such as a format of the input data and continuity of the input data. The continuity means that there is some commonality between data in the list (in this case, the same point), for example, “counting pedestrians in images captured at different times by a monitoring camera at the same point and displaying a graph of the number of pedestrians for each time”. Conversely, the absence of continuity means that there is no commonality between data in the list, such as “counting pedestrians in images captured by monitoring cameras at a plurality of points and displaying a graph of the number of pedestrians for each point”. The information on the continuity is used by the data generation unit 104. When the format of the data is a list, the instruction generation unit 103 generates a instructional sentence (=prompt) for each element of the list. The presence or absence of continuity can be determined by the LLM at the same time as the generation of the data generation instruction, or may be classified into presence or absence using another classification model.

For example, when the format of the input data is a plurality of images, the input data generation method includes information indicating whether or not the plurality of images have continuity. In addition, in a case when the format of the input data is one piece of audio data, information indicating whether the input data includes voice or speech, includes an environmental sound, or includes both of them is included.

Since there may be a plurality of input data to the process workflow instead of one, the instruction generation unit 103 outputs a data generation instruction according to the format of the input data for each necessary input data. The data generation instruction includes an instruction to be input to a generation unit for each format of data used in the data generation unit 104, and an input data generation method of the instruction.

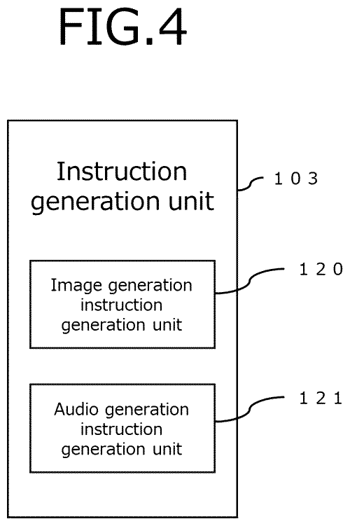

FIG. 4 is a schematic diagram illustrating a functional configuration of an instruction generation unit of the information processing apparatus according to the first embodiment. The instruction generation unit 103 includes an image generation instruction generation unit 120 and an audio generation instruction generation unit 121. In the present embodiment, it is considered that the format of the input data is an image, an audio, other types, or a list thereof. For example, video or text data may be used as the format of the input data.

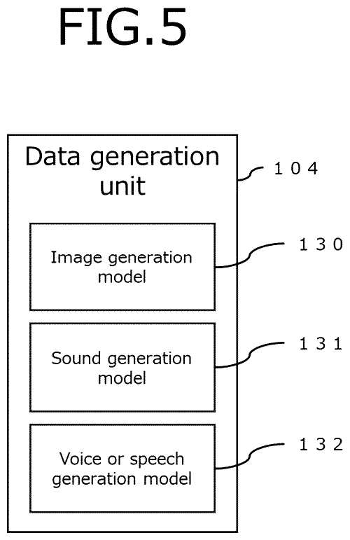

The data generation unit 104 actually generates input data in accordance with the instructional sentence (prompt) of the input data generated by the instruction generation unit 103, the selected input data generation method, and the format of the input data generated by the planning unit 102. FIG. 5 is a schematic diagram illustrating a functional configuration of a data generation unit of the information processing apparatus according to the first embodiment. The data generation unit 104 includes an image generation model 130, a sound generation model 131, and a voice or speech generation model 132. In addition, in the present embodiment, the input data to be generated is considered to be an image, a sound, or an audio, but for example, a video or a text may be used as the input data.

The execution unit 105 executes the process workflow by applying the input data generated by the data generation unit 104 as an input to the source code corresponding to the process workflow generated by the planning unit 102. The execution unit 105 may be capable of outputting an intermediate result during the period from executing the process workflow using the input data to outputting the execution result.

The display control unit 106 displays the execution result of the execution unit 105 and the API execution sequence information stored in the storage unit 109 on a display or the like in association with each other. The display unit (not shown) is connected to the display control unit 106, and the display unit is configured by any one of a monitor, a printer, and a projector, for example. In a case when the information processing apparatus according to the present embodiment includes a touch panel, the touch panel may have both functions of the acquisition unit 101 and the display unit. In the above embodiment, the display control unit 106 may be mounted on a cloud or the like, and the display described above may be performed on the display unit of a local device of the user. As described above, when the execution unit 105 is capable of outputting the intermediate result, the display control unit 106 may be configured to cause the display unit to display process flow information included in the process workflow, the input data, the execution result, and the intermediate result. In this case, it is preferable to display the process flow information and the intermediate result on the display unit in association with each other.

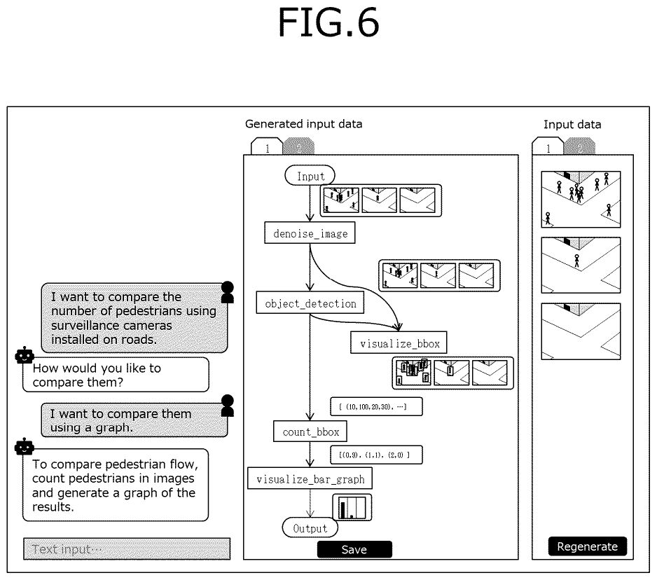

FIG. 6 is a schematic diagram illustrating a display example of the information processing apparatus according to the first embodiment. A display section related to the API execution sequence information is provided at the center of the screen, and a display section related to the generated input data is provided on the right side of the screen.

The input interface (I/F) 110 connects the information processing apparatus 100 and the acquisition unit 101. The input interface 110 may be, for example, a keyboard or a pointing device. The CPU 113 can read the request sentence from the acquisition unit 101 via the input interface 110.

An output interface (I/F) 111 connects the information processing apparatus 100 and the display control unit 106. The output interface 111 is a video output interface such as a digital visual interface (DVI) or a high definition multimedia interface (HDMI) (registered trademark). Further, a display for displaying various types of information, and a speaker for reproducing audio data when audio data is handled may be used. The CPU 113 transmits the information to the display control unit 106 via the output interface 111. The display control unit 106 outputs data.

The communication interface (I/F) 112 connects the planning unit 102, the instruction generation unit 103, the data generation unit 104, and the execution unit 105 outside the processing device 300 to the information processing apparatus 100. The communication interface 112 is, for example, a network card such as a LAN card. The CPU 113 can read various types of information from the planning unit 102, the instruction generation unit 103, the information generating unit 104, and the execution unit 105 via the communication interface 112. The planning unit 102, the instruction generation unit 103, the data generation unit 104, and the execution unit 105 do not necessarily need to be connected via the communication interface 112, and may be included in a CPU 113 or a ROM 114.

The actual processing procedure will be described below. In the present embodiment, after the acquisition unit 101 acquires a request, the generation of a process workflow, the generation of input data, and the execution of the process workflow are automatically performed, and the execution result is displayed. After viewing the display content of the process workflow, the user may input content such as further adding a request or changing a request using the acquisition unit 101. When the request is changed, the execution result of the process workflow for the changed request can be displayed by executing this processing again. At this time, if there is no change in the type of the input data, the input data before the request change is used as it is. This makes it possible to check how the execution result of the process workflow has changed due to the change in the request.

### Step S100

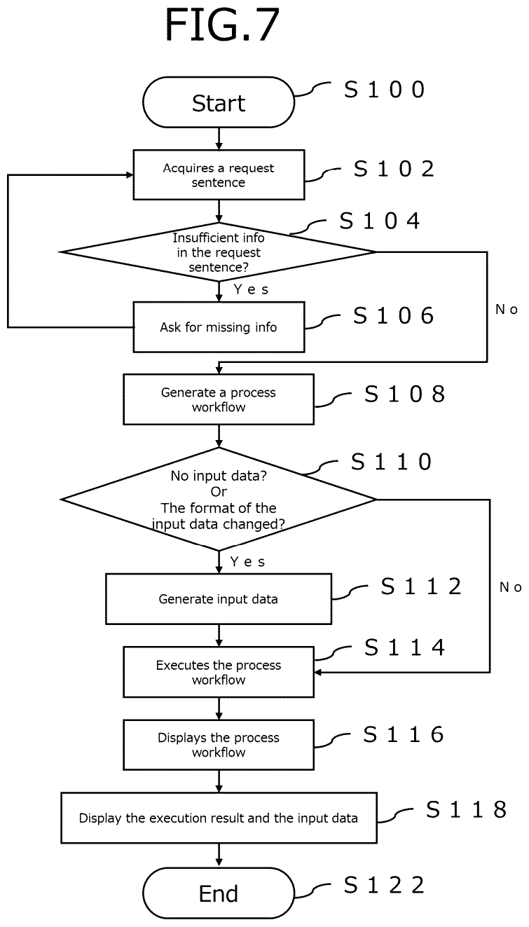

FIG. 7 is a flowchart illustrating the entire process of the information processing apparatus according to the first embodiment. In the information processing apparatus according to the first embodiment, the entire process starts.

### Step S102

An acquisition unit 101 acquires a request sentence of a user.

In order to generate input data corresponding to a use case of a user, it is desirable that the request sentence includes three elements of “a purpose to be executed”, “a process workflow”, and “data or an object to be a target of the process workflow”. For example, in the case of a request “to track the location of a suspicious person using a plurality of monitoring cameras installed in a store”, the purpose is “tracking of a specific person”, the process workflow is “analysis of a plurality of monitoring camera images”, and “suspicious person” and “monitoring camera image” are data or an object to be a target. In addition, in a case of a request “to graph the number of pedestrians for each time using a monitoring camera installed on a road”, “graph the number of pedestrians for each time” is an purpose, “acquire data from the monitoring camera installed on the road, aggregate the number of pedestrians, and generate a graph” is a process workflow, and “data of pedestrians acquired by the monitoring camera installed on the road” is data or a target to be a target. Three elements of “a purpose to be executed”, “a process workflow”, and “data or an object to be a target” are not necessarily described independently, and the contents of the respective elements may be duplicated. For example, in the case of a request sentence “I want to detect rust on a bridge and measure the size thereof”, the purpose is “measure the size of rust on a bridge”, the process workflow is “detect rust and measure the size thereof”, and “bridge, rust” is data or an object to be a target. At this time, the purpose and the process workflow are almost the same. The example that the contents of the respective elements may overlap each other indicates such a case.

The request sentence may be acquired by displaying a text box on the screen as in a general chat interface as shown on the left side of the screen shown in FIG. 6, and the user may input text in the text box using a keyboard. The method of acquiring the request sentence is not limited to this, and the request sentence may be input using an audio interface. The purpose, the process workflow, the data or the object to be a target may be separately input even in a case when the request sentence is input as text. When the input is performed through the audio interface, the text of the audio recognition result may be handled as the input of the processing described below, and when the input is performed by dividing the input into the purpose, the process workflow, the data or the object to be a target, the connected text may be handled as the input of the processing described below.

### Step S104

The acquisition unit 101 determines whether the acquired request sentence includes three elements of “a purpose to be executed”, “a process workflow”, and “data or object to be a target of the process workflow”.

If the above-described three elements (the purpose, the process workflow, and the data or object to be a target) are not included in the sentence input by the user, the system may return an inquiry to prompt the user to input the information again. This can be realized by making the LLM determine whether or not the three elements are complete in the user's sentence, and if they are not complete, inputting a prompt asking the user about the contents. The prompt is generated using the prompt template of FIG. 3. If there is still insufficient information necessary for generating the process workflow, the user may be asked again for details. For example, when the user's request sentence is “I want to detect rust on a bridge and measure the size thereof”, the LLM response includes
the purpose: detect rust on a bridge and measure the size thereof,
the process workflow: detect rust and measure the size thereof,
the target data and object: bridge,
   and
the sentence to inquire the user: null character string.
   In addition, in a case when the user's request sentence is “I want to detect rust”,
the purpose: detect rust,
the process workflow: not present,
the target data or target object: not present,
   and
the sentence to inquire the user is: “Do you know about the data or object to be a target specifically?”,
   And each reply is analyzed and the user is inquired as necessary.

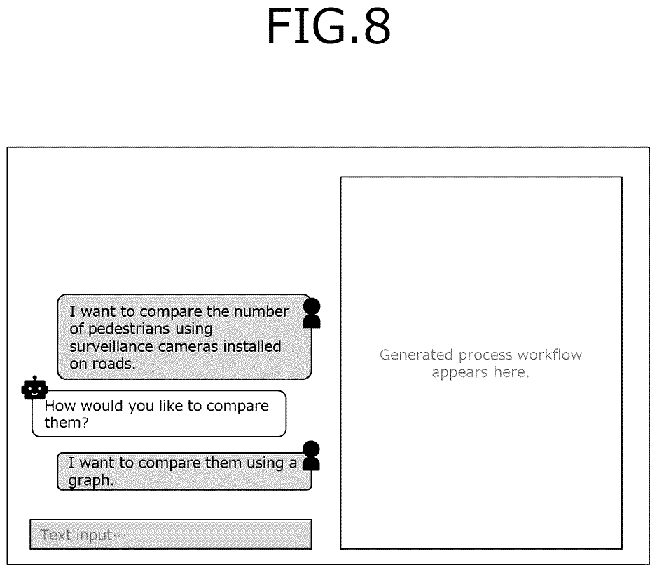

FIG. 8 is a schematic diagram illustrating an example of an acquisition unit of the information processing apparatus according to the first embodiment. The left half of the screen is the chat interface of the acquisition unit, the right half is the screen, and a text box for the user to input a request is displayed at the bottom area of the screen. The request sentences input in the text boxes are sequentially displayed as speech balloons from the bottom in the chat interface. Further, an inquiry from the system for completing the request sentence is also displayed as a balloon.

### Step 106

In step S104, when it is determined that the information of the request sentence is insufficient, the acquisition unit 101 inquires the user about the request sentence.

When the inquiry is made at step S106, the acquisition unit 101 acquires the request sentence of the user again at step S102.

### Step S108

In step S104, when it is determined that the information of the request sentence is satisfied, the planning unit 102 associates the process flow information with the corresponding API information stored in the storage unit 109 to generate an executable process workflow.

In the API information, there is a description of a corresponding argument for all arguments described in the signature. This is a case when the API is an API such as a so-called library, and in a case when the target API is a Web API, instead of this, the API name, the description, the type of input data, the description of the input data, the type of output data, the description of the output data, and information on the way of calling such as the URL or Method of the Web API may be included.

The process workflow may be performed using any existing method. For example, in Non-Patent Document, “Yujia Qin, Shihao Liang, Yining Ye, Kunlun Zhu, Lan Yan, Yaxi Lu, Yankai Lin, Xin Cong, Xiangru Tang, Bill Qian, Sihan Zhao, Lauren Hong, Runchu Tian, Ruobing Xie, Jie Zhou, Mark Gerstein, Dahai Li, Zhiyuan Liu, Maosong Sun, ToolLLM: Facilitating Large Language Models to Master 16000+Real-world APIs [online], Oct. 3, 2023, Artificial Intelligence, [retrieved on Dec. 17, 2024], Internet <URL: [2307.16789] ToolLLM: Facilitating Large Language Models to Master 16000+Real-world APIs>”, a source code is generated by using an existing source code generation technique using an API, and API execution sequence information is extracted from the source code, thereby generating the API execution sequence information.

The method of generating input data of the process workflow of the planning unit 102 is not limited to this, and any other method may be used. For example, the instruction ‘Generate a process workflow using all API information, user request sentence, and the API’ should be input into the LLM prompt. However, when the number of APIs stored in the storage unit increases, or when the storage unit 109 is not explicitly provided and the search is performed from the API information list on the Web, it is difficult to input all the API information to the LLM.

Therefore, in the present embodiment, the process workflow is generated in the following procedure. First, a process workflow is generated as a plurality of pieces of process flow information instead of an API. This can be realized by inputting a request sentence and an instruction to output the process flow information to the LLM. The process flow information has a structure in which a node is a process name and a description thereof and an edge is a combination thereof, and this can be represented in a text format such as JSON and can be output by a general LLM.

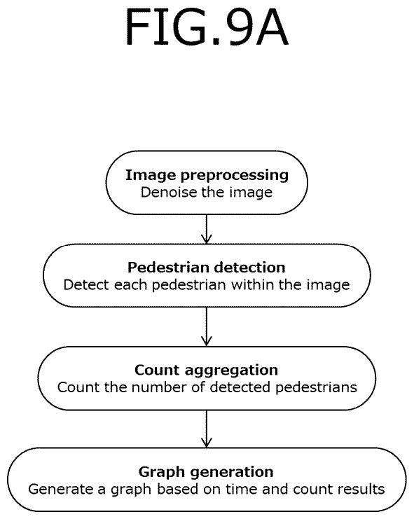

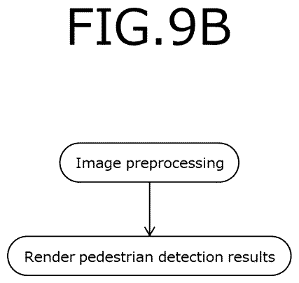

FIG. 9A is a schematic view illustrating process flow information of the information processing apparatus according to the first embodiment. For example, in the case of a request sentence “I want to graph the number of pedestrians for each time using a monitoring camera installed on a road”, a combination graph of the process flow information as shown in FIG. 9A can be generated.

Next, the storage unit 109 is searched for an API that matches each process of the process flow information. This can be realized by vectorizing the process description, vectorizing the API description in the same manner, and extracting (performing a vector search) the API description having a high similarity in vector to the process description. Here, the process description refers to an description of each process, and the API description refers to a description of a process performed by each API.

FIG. 9B is a schematic view illustrating the process flow information of the information processing apparatus according to the first embodiment. Since there is a possibility that an API that matches one to-one is not found, a plurality of APIs having a high similarity are extracted, the LLM is instructed to generate a partial process workflow that matches the content of the process description using only the extracted APIs, and the actually generated partial process workflow is set as a final API search result. In this way, when there is an API corresponding to a process one to one, one corresponding API is obtained. In addition, in a case when there is no API corresponding to the processing one to-one, a plurality of pieces of API execution sequence information (partial process workflow) are obtained.

In the case of the process flow information in FIG. 9A, there are APIs corresponding to the respective processes on a one to-one basis, and the image preprocessing is denoise_image, the pedestrian detection is object_detection, the count aggregation is count bbox, and the graph generation is count bbox. Further, for example, in a case when the generated process flow information is “image preprocessing (noise reduction)”→“graph of pedestrian detection result” as in FIG. 9B, there is no API corresponding to “graph of pedestrian detection result” on a one to-one basis, and a combination of two APIs of “detection of pedestrian (object detection)”→“graph of detection result (visualize bbox)” is required. At this time, the corresponding API execution sequence information is “object_detection→visualize bbox”.

When the API or the API execution sequence information corresponding to the processing of the process flow information is obtained, the processing of the process flow information is replaced with the API or the API execution sequence information.

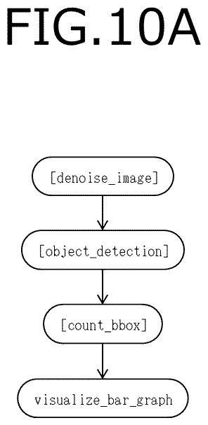

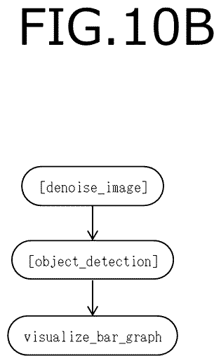

FIG. 10A is a schematic view illustrating a result of generating API execution sequence information of the information processing apparatus according to the first embodiment related to the process flow information of FIG. 9A. FIG. 10B is a schematic view illustrating a result of generating the API execution sequence information of the information processing apparatus according to the first embodiment related to the process flow information of FIG. 9B. The API name enclosed in brackets [] indicates that a plurality of data (here, a list of images) are handled. The format of the input data is determined from the information of the start point of the process flow information. That is, denoise image is performed for each image data in the list of images, and object detection is performed for each result image of denoise image. Thus, in this graph, the format of the input data is a list of images. In addition, in a case when the notation without [] is used, one image is output.

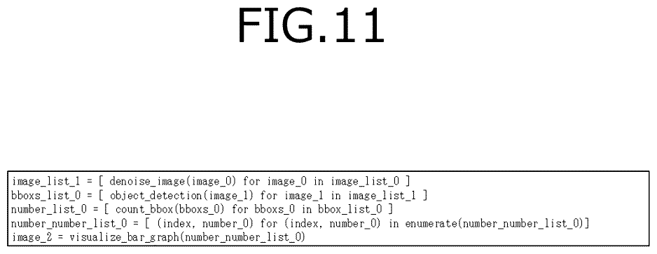

FIG. 11 is a diagram illustrating a source code of the information processing apparatus according to the first embodiment. In order to make the process workflow executable, an executable source code is generated based on the process workflow. The LLM can also be used to generate source code. In particular, when there is a mismatch in the I/O type of API between the APIs, it is highly likely that source code generation for converting the types is necessary. Here, the mismatch of the I/O type of API means that the type of the return value of the previous API and the type of the argument of the next API do not match.

For example, when there is an API called “detect nearest_fallen object (Image)”, it is considered that the processing content is “detect the position of the nearest fallen object in the image”, the argument description is “image”, and the return value description is “detection rectangle”. At this time, the return value of the detection rectangle is, for example, data of one detection rectangle such as (x, y, width, height). In contrast, when the request sentence is “to detect a fallen object at a near position and display the position thereof in order to warn of a fallen object to be handled next”, it is desired to use visualize bbox (Image, List [(num, num, num, num)]) in FIG. 2 as the API execution sequence information to change “detect nearest fallen object”→“visualize bbox”. Here, the second argument of “visualize bbox” is a ‘list of detection rectangle’, so data like [the first (x, y, width, height), the second (x, y, width, height), . . . ] is required. This is referred to as a mismatch in the I/O type of APIs. That is, in order to connect these two APIs well, a source code for converting the output (x, y, width, height) of “detect nearest fallen object” into a list [(x, y, width, height)] is required.

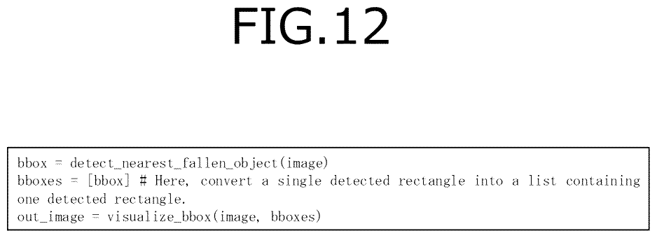

FIG. 12 is a schematic view illustrating conversion of the type of the API of the information processing apparatus according to the first embodiment. By inputting the API execution sequence information and the original request sentence to the LLM to generate the source code, the entire source code including the source code of the data format conversion can be generated. In this way, the process workflow and the source code corresponding to the API execution sequence information are generated. Although the source code of Python is generated in the present embodiment, a source code of any programming language may be generated as long as the source code can be executed by the execution unit.

### Step S110

The instruction generation unit 103 determines whether there is input data or whether the format of the input data has been changed.

### Step S112

If it is determined in step S110 that there is no input data or that the format of the input data has been changed, the data generation unit 104 newly generates input data.

The data generation unit 104 selects one or a plurality of generation models for each input data according to the format of the input data and generates the input data by inputting an instruction to the selected individual format generation unit. The data generation unit 104 actually generates input data in accordance with the instructional sentence (prompt) of the input data generated by the instruction generation unit 103 and the selected format of the input data generated by the planning unit 102.

The format of the input data is not limited to image or audio, and may be video, text, numerical data, or the like. In any format, similarly, an instructional sentence (=prompt) for generating data is generated using a request sentence of the user (a detailed request sentence in which three elements are prepared), a process workflow (API execution sequence information and formats of input data) generated by the planning unit 102, and a description of an API used in the process workflow. Note that these generation processes may be performed for each necessary input data or may be performed collectively.

In the present embodiment, designation of the presence or absence of continuity at the time of data generation is used as an input data generation method. When the format of the input data is a list of something such as a list of images or a list of audios, it is also determined whether there is continuity between the generated data at the time of generation.

The data generation unit 104 can generate a plurality of sets of input data by executing the processing a plurality of times. Since the generation result changes for each execution even with the same prompt depending on the generation model, it is desirable to generate a plurality of pieces of input data so as to include input data matching a use case considered by the user. This means that the data generation unit 104 performs data generation processing a plurality of times for one instruction generated by the instruction generation unit 103, and holds the result on the memory. The information may be stored in a file or the like.

### Step S114

If it is determined in step S110 that the input data already exists or the format of the input data has not been changed, the execution unit 105 inputs the input data to the process workflow and executes the process workflow.

In order to execute the process workflow by the execution unit 105, an execution environment of the source code generated by the planning unit 102 is necessary. In the present embodiment, it is considered that the source code is a Python source code and the execution environment is a Python execution environment. Each API must also be executable in the same manner. In the case of a Web API, an external Web API may be called. When executing the process workflow, input/output data of the API call in the source code is stored in association with the API.

### Step S116

The display control unit 106 displays the process workflow and the execution result on the display unit in association with each other.

The display control unit 106 displays the input data, the data before and after each API, and the data after the completion of the execution of the process workflow (input data application result) on the display unit in association with each part of the graph. The display control unit 106 may use either a display method capable of selecting a plurality of process workflows and corresponding input data execution results and displaying the plurality of process workflows and the corresponding input data execution results, or a display method capable of selecting one process workflow and corresponding input data execution result and displaying only one process workflow and corresponding input data execution result. However, the display between the connected APIs is only one of the display before the processing of the API and the display after the processing of the API. When a plurality of pieces of input data are generated, the input data to be displayed, the data before and after the API, and the data of the application result are switched in accordance with switching of the input data to be used in the display unit related to the input data. A “save” button is provided at the bottom area of the screen related to the API execution sequence information, and when the user pushes this button, the source code is saved. In addition, a plurality of types of process workflows may be generated, and in this case, a switching button is displayed on an upper area of the screen related to the API execution sequence information.

The display control unit 106 may be configured to change the API execution sequence information. For example, a node may be deleted by selecting “delete” from a right-click menu of a specific node. When the API execution sequence information is changed, the process of generating the source code from the process workflow of the planning unit 102 and the subsequent processes may be executed again.

### Step S118

The display control unit 106 causes a display unit such as a display to display the execution result of the execution unit 105 and the input data.

### Step S122

The entire process is terminated.

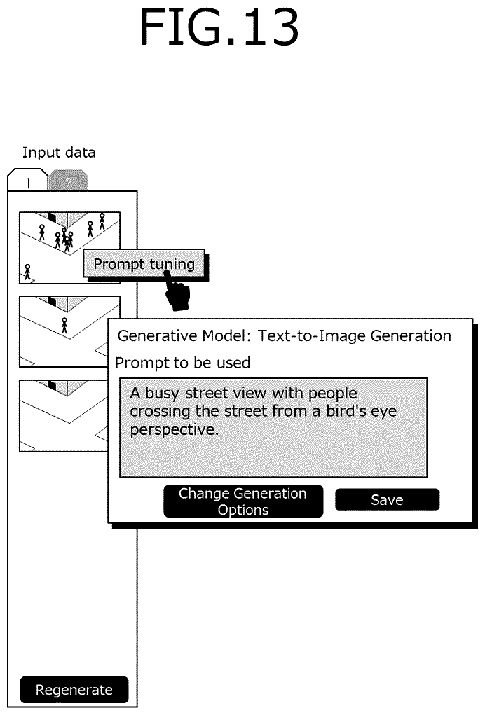

FIG. 13 is a schematic diagram illustrating an interface for performing prompt editing of input data of the information processing apparatus according to the first embodiment. The display control unit 106 displays the set of input data on the screen. As shown in FIG. 13, the user may be allowed to adjust the data generation instruction (prompt) for each input data. In this screen, when the user selects the prompt editing by right-clicking on the input data, a prompt for generating the current data is displayed in the text box.

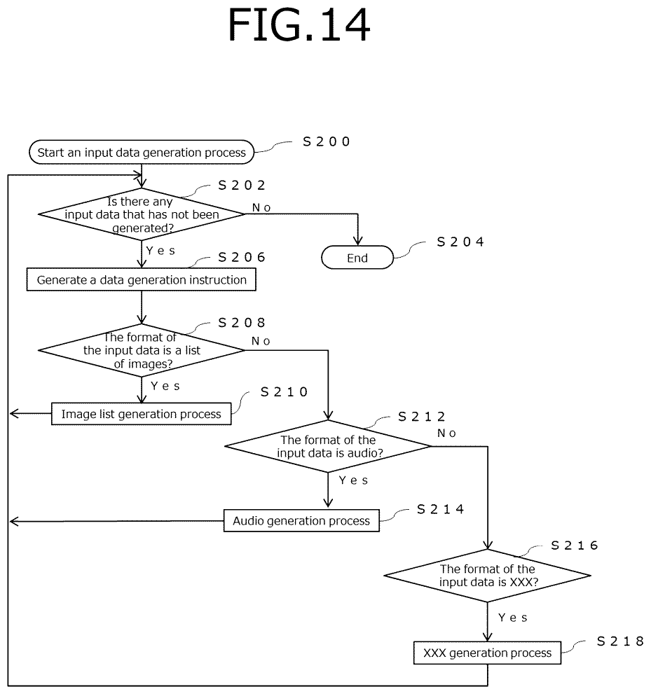

FIG. 14 is a flowchart illustrating an input data generation process of the information processing apparatus according to the first embodiment.

### Step S200

The process is started.

### Step S202

It is determined whether there is input data that has not been generated.

### Step S204

When it is determined that the input data is generated in step S202, the input data generation process is ended.

### Step S206

When it is determined that the input data is not generated in step S202, the instruction generation unit 103 generates a data generation instruction again.

### Step S208

The data generation unit 104 determines whether the format of the input data is a list of images.

### Step S210

When it is determined in step S208 that the format of the input data is a list of images, the image list generation process is performed by the data generation unit 104. After the image list is generated, it is determined again in step S202 whether or not there is any image that has not been generated.

### Step S212

When it is determined in step S208 that the format of the inputted data is not a list of images, the data generation unit 104 determines whether the format of the input data is audio.

### Step S214

When it is determined in step S212 that the format of the input data is audio, audio generation process is performed in data generation unit 104. After the audio is generated, it is determined again in step S202 whether or not there is any input data that has not been generated.

### Step S216

When it is determined in step S212 that the format of the input data is neither a list of images nor audio, the format of the input data is determined in data generation unit 104.

### Step S218

When the format of the input data is determined, the data generation unit 104 performs generation processing. After the generation of the input data, it is determined again whether there is input data that has not been generated in step S202.

In order to generate a generation instruction of audio data, it is necessary to distinguish whether the type of audio data is “voice or speech (human speech)”, “sound (environmental sound)”, or a combination thereof (human speech in a specific environment). This is because the audio generation model used by the data generation unit 104 is completely different between a voice or speech generation model (so-called text-to-speech in which speech content is specified in text to generate speech) and a sound generation model (in which an description of the content of sound is specified in text to generate sound).

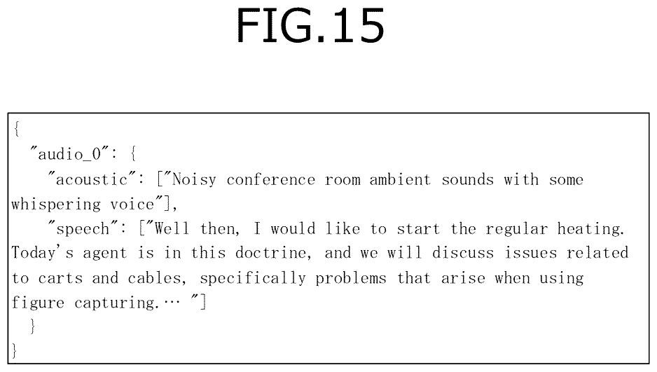

In a case when the format of the input data is audio, “whether or not human voice or speech is included” and “whether or not sound other than human voice or speech is included” are also used as the input data generation method. FIG. 15 is an illustration of an audio generation instruction of the information processing apparatus according to the first embodiment. FIG. 15 shows an example of a data generation instruction generated in response to a request such as “I want to generate minutes from the audio of a conference. Please include action items in the minutes. Correct misrecognition included in an audio recognition result.” The data generation instruction is an example of a data generation instruction generated for “Do you want to use the data?”. In this example, both of “whether or not human voice or speech is included?” and “whether or not sound other than human voice or speech is included?” are True (included), therefore “speech” which is speech content of human voice or speech and “prompt acoustic” for generating sound data other than human voice or speech are included. When the human voice or speech is not included, the speech property may be set to be absent. In the example, both “acoustic” and “speech” are in a list format, which indicates that a plurality of pieces of audio data can be generated. In this example, a simple text character string is generated for “speech”, but in the case of a conversation between a plurality of persons, a tag representing a speaker class may be included. For example, “<change speaker sp=“speaker0”/>Are you dining in? <change speaker sp=“speaker1” />No, I'll take it to go.” may be used to represent a conversation between a plurality of people.

Therefore, when the format of the input data is audio, it is necessary to determine “whether the input data includes human voice or speech” or “whether or not sound other than human voice or speech is included”, and when the input data includes voice or speech, prompt for generating audio data is generated using the speech content text. And when the input data includes sound, prompt for generating audio data is generated using a sound generation model. Any number of pieces of voice or speech data and sound data may be generated, and are synthesized in the subsequent processing. For example, in a case of a request such as “I want to recognize a conversation between a cafe staff and a customer in a cafe and digitize an order”, voice or speech content of the cafe staff (such as “Are you dining in?” or “Which size would you like?”) or voice or speech content of the customer (such as “I'll take it to go.” or “Regular, please.”) as speech content text for the voice or speech data, and “BGM of an instrumental” or “the hum of the cafe” as prompt for the sound data for reproducing the sound of the cafe are generated.

This generation may be performed at once by the LLM, or it may be determined “whether the input data includes human voice or speech” or “whether or not sound other than human speech is included” by using another classification model, and the speech content text and the sound generation prompt may be generated one by one by the LLM as necessary based on the determination.

In any case, when generating the speech content or the sound content prompt, the prompt includes a request sentence of the user (a detailed request sentence including all three elements), a process workflow generated by the planning unit (the format of the API execution sequence information and the input data), and a description of the API used in the process workflow, as in the case of generating the image generation instruction.

When the format of the input data is an audio or a list of audios, a voice or speech generation model (speech synthesis, text-to-speech) and a sound generation model are selected as the generation model. Any existing model may be used for both. For example, a model such as Non-Patent Document, “lacombe-etal-2024-parler-tts, parler-tts/parler-tts-mini-v1 [online], [retrieved on Dec. 17, 2024], Internet <URL: parler-tts/parler-tts-mini-v1 Hugging Face>”, can be used for the voice or speech generation model, and a model such as Non-Patent Document, “Make-An-Audio: Text-To-Audio Generation with Prompt-Enhanced Diffusion Modes, Rongjie Huang, Jiawei Huang, Dongchao Yang, Luping Iiu, Mingze Li, Jinglin Liu, Xiang Yin, Zhou Zhao, 30 Jan. 2023”, can be used for the sound generation model.

### (First Modification of First Embodiment) (Audio Data)

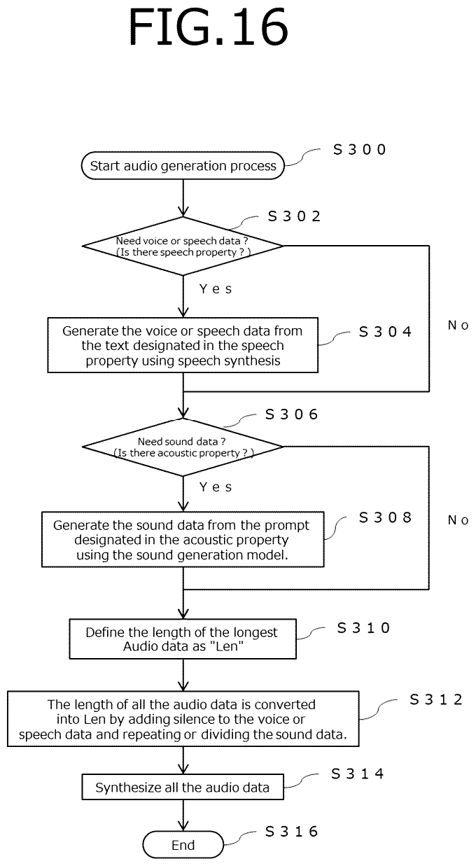

FIG. 16 is a flowchart illustrating an audio generation process of the information processing apparatus according to the first embodiment.

### Step S300

The process is started.

### Step S302

It is determined whether or not the input data of the audio to be generated requires the uttered voice or speech data. The voice or speech data refers to a speech-like audio or spoken voice as if a person speaks.

### Step S304

In step S302, when it is determined that the voice or speech data is necessary, the voice or speech data is generated from the text designated in the speech property using the voice or speech generation model. The speech property refers to the term of speech in the example of the voice or speech generation instruction of the information processing apparatus according to the first embodiment in FIG. 16.

### Step S306

When it is determined in step S302 that the voice or speech data is not required, or when step S304 is completed, it is determined whether or not the sound data is required. The sound data refers to audio data that is not voice or speech data, such as music, environmental sound, or animal call or the like.

### Step S308

In step S306, when it is determined that a sound data is required, the sound data is generated from the prompt designated in the acoustic property using the sound generation model. The acoustic property refers to the term of acoustic in the example of the audio generation instruction of the information processing apparatus according to the first embodiment in FIG. 16.

### Step S310

When it is determined in step S306 that the sound data is not required, or when step S308 is completed, the length of the longest audio data among the generated audio data is defined as “Len”. The audio data refers to both sound data and voice or speech data.

### Step S312

Next, the length of all the audio data is converted into Len by adding silence to the voice or speech data and repeating or dividing the sound data.

### Step S314

Next, all the audio data are synthesized.

### Step S316

The audio generation process ends.

For example, in the case of FIG. 15, the user inputs a message “Well then, I would like to start the regular heating. Today's agent is in this doctrine, and we will discuss issues related to carts and cables, specifically problems that arise when using figure capturing.” into the Text-to-Speech to obtain voice or speech data. Next, “Noisy conference room ambient sounds with some whispering voice” is input to the sound generation model to obtain sound data. These are synthesized to obtain audio data.

In order to generate the image data generation instruction, a prompt to be input to the image data generation model and information as to whether or not a plurality of pieces of data are generated and whether or not the relationship between the plurality of pieces of data is independent (there is no continuity) or dependent (there is continuity) in the case of the plurality of pieces of data as an input data generation method are generated using the LLM. At this time, the prompt includes a request sentence of the user (a detailed request sentence including three elements), a process workflow (the format of the API execution sequence information and the input data) generated by the planning unit, and a description of the API used in the process workflow. The description of the API may be used by acquiring the description of the processing content of the API from the storage unit 109. In this case, the prompt is generated so as to include the style (illustration, photorealistic, monochrome, etc.) of the image to be generated, the main theme (subject), the viewpoint, etc.

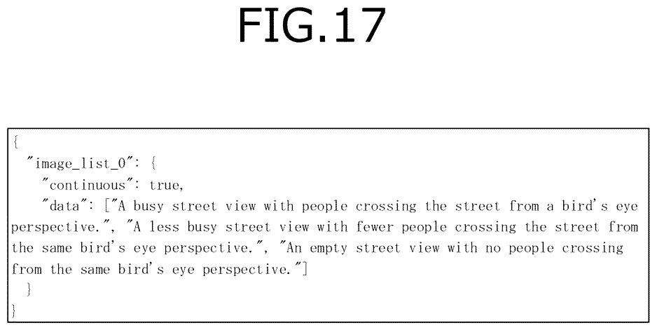

FIG. 17 is an example of an image list generation instruction of the information processing apparatus according to the first embodiment. FIG. 17 is an example of a data generation instruction generated for a request “counting pedestrians in images captured at different times by a monitoring camera at the same point and displaying a graph of the number of pedestrians for each time”. In this example, since a plurality of images of the monitoring camera at the same point are input, “continuity”, that is, “continuous” is “true”. Further, three prompts for generating three images as the plurality of images are included in the data.

For example, when the format of the input data is an image or a list of images, an image generation model is selected as the generation model. Any existing model may be used as the image generation model, but both a model capable of generating an image from a text prompt (text-image generation model) and a model capable of generating an image from an image and a text prompt (image-image generation model), or a generation model having both functions is required. For example, a model as in Non-Patent Document, “RunDiffusion, Juggernaut XL v9+RunDiffusion Photo v2 Official [online], [retrieved on Dec. 17, 2024], Internet <URL: RunDiffusion/Juggernaut-XL-Hugging Face v9>” can be used.

### (First Modification of First Embodiment) (Image Data)

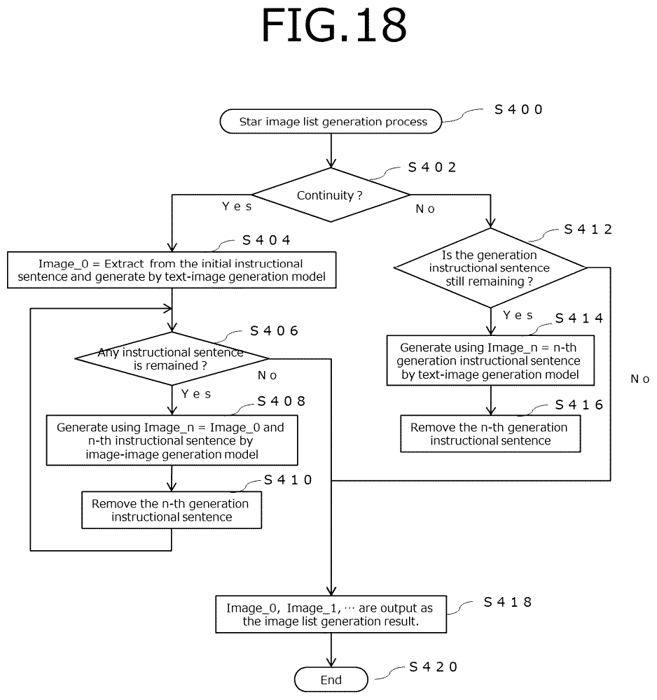

FIG. 18 is a flowchart illustrating an image list generation process of the information processing apparatus according to the first embodiment.

### Step S400

The process is started.

### Step S402

When the input data is a list of images, it is determined whether there is continuity.

### Step S404

When it is determined in step S402 that there is continuity, in step S404, the 0th instructional sentence among the plurality of instructional sentence (prompts) is input to a model (text-image generation model) capable of converting and generating an image from text, and the generated image is set as Image_0.

### Step S406

It is determined whether any instructional sentence is remained.

### Step S408

When it is determined in step S406 that at least one instructional sentence is remained, in step S408, the n-th instructional sentence among the plurality of instructional sentence (prompts) and the image Image_0 generated in step S404 are input to a model (image-image generation model) capable of generating an image from an image and a text, and the generated image is set as Image_n.

### Step S410

Remove the n-th instructional sentence. Steps S406 to S410 indicate that the processing is repeated until there is no more instructional sentence generated by the instruction generation unit 103.

### Step S412

When it is determined in step S402 that there is no continuity, it is then determined whether there is any remaining instructional sentence generated by the instruction generation unit 103.

### Step S414

When it is determined in step S412 that at least one instructional sentence is remained, the instructional sentence_n is input to the text-to-image generation model to generate an image, and the generated image is denoted by Image_n.

### Step S416

Next, the instructional sentence_n is removed. Steps S412 to S416 indicate that the processing is repeated until there is no more instructional sentence generated by the instruction generation unit 103.

### Step S418

When it is determined in step S406 that no instructional sentence remains, or when it is determined in step S412 that no instructional sentence remains, Image_0, Image_1, . . . are output as the image list generation result.

### Step S420

After the image list is generated, the process ends.

For example, in the case of the instruction in FIG. 17, since “continuous” indicating continuity is true, “A busy street view with people crossing the street from a bird's eye perspective” is input to the text-image generation model, and the output image is set as the first image. Next, the first image and “A less busy street view with few people crossing the street from the same bird's eye perspective.” are input to the image-image generation model, and the output image is set as the second image. Similarly, the first image and “An empty street view with no people crossing from the same bird's eye perspective.” are input to the image-image generation model, and the output image is set as the third image. Finally, [the first image, the second image, the third image] is set as input data.

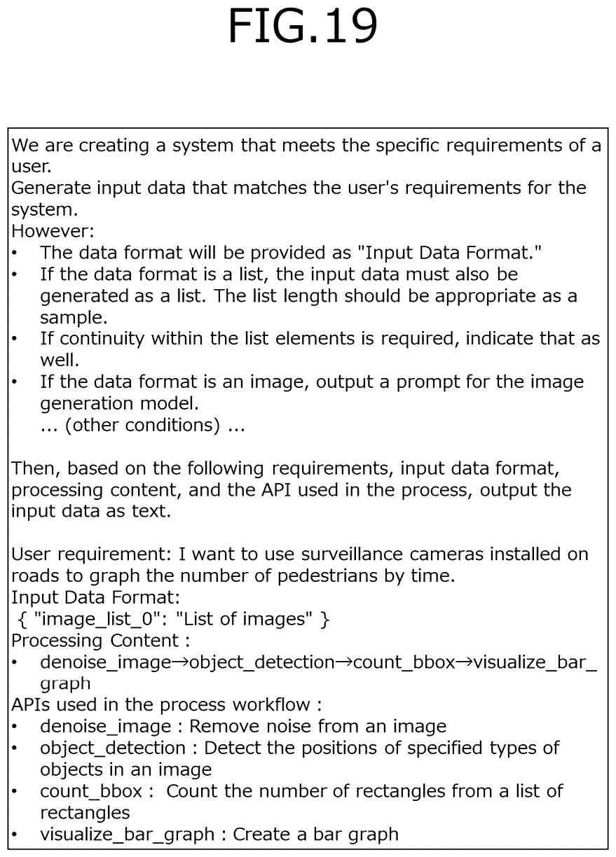

FIG. 19 is an example of a prompt for instruction generation of the information processing apparatus according to the first embodiment. This shows an example in which the format of the input data is a list of images. In this way, a template of a prompt for a format of specific input data may be prepared and used, or prompts for formats of a plurality of or all input data may be combined into one. It should be noted that this prompt example is a very simplified example, and prompt engineering may be further performed. For example, prompt engineering may be performed, such as giving some generation examples in advance, generating in several stages (such as generating a prompt after determining continuity), and defining the format of data to be output (prompt and input data generation method).

Note that the input data generation method for data generation is not limited to this, and in the generation of video and signals, the instruction generation unit may output the input data generation method, and data may be generated based on the input data generation method. For example, in the case of a video, control may be performed so as to designate the length of the video. Also, in the generation of the image list, control may be performed such that a background image is generated, a plurality of foreground images are generated, and the foreground images are sequentially superimposed on the background image to generate the image list.

Similarly, in the case when the data generation unit 104 generates data in the format of video, signal, or text, any existing model may be used as long as the text (prompt) of the generation instruction is input and data in the format can be generated.

When a plurality of process workflows are generated by the planning unit 102, the input data generation process may be executed for each process workflow. In a case when a plurality of process workflows are generated, the user can easily confirm which process workflow is to be selected by making it possible to confirm a difference in the application result of the input data by the process workflow. In order to generate a data generation instruction that enables the difference to be confirmed, prompt engineering may be used, that is, an instruction to generate data that enables the difference to be confirmed may be included in a prompt.

### Second Embodiment

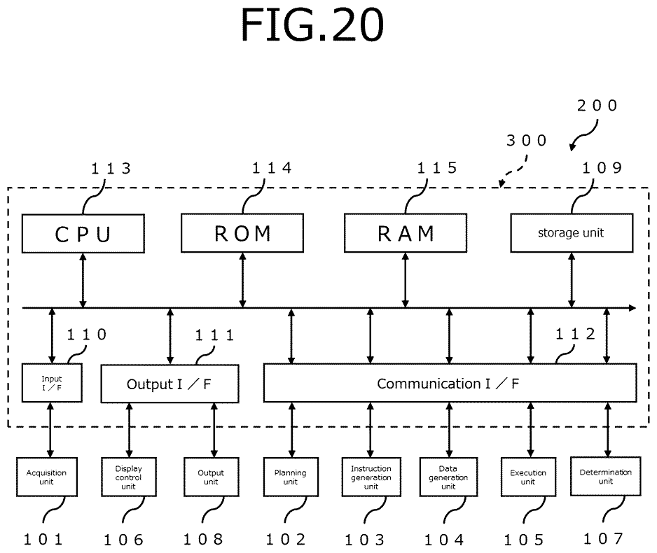

FIG. 20 is a block diagram illustrating a functional configuration of an information processing apparatus according to a second embodiment. As illustrated in FIG. 20, the information processing apparatus 200 according to the second embodiment includes an acquisition unit 101, a planning unit 102, an instruction generation unit 103, a data generation unit 104, an execution unit 105, a display control unit 106, a determination unit 107, an output unit 108, and a storage unit 109. The information processing apparatus 100 according to the second embodiment is different from the information processing apparatus 100 according to the first embodiment in the presence or absence of the determination unit 107 and the output unit 108.

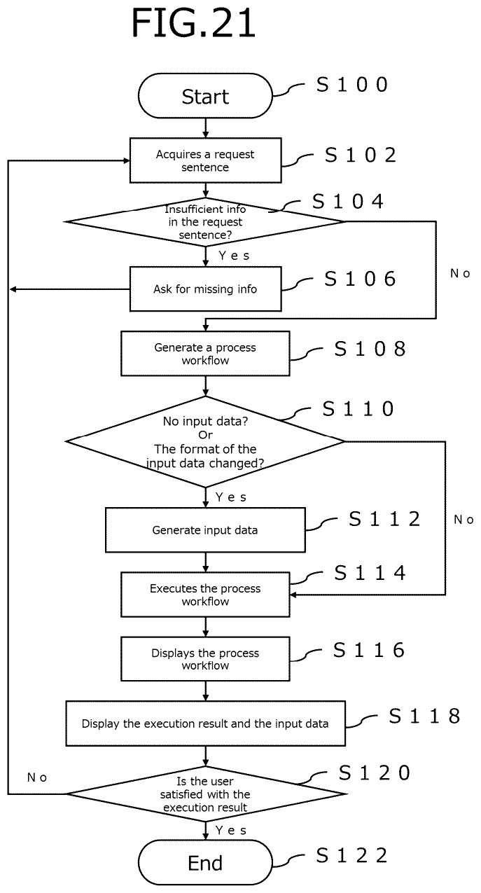

FIG. 21 is a flowchart illustrating the entire process of the information processing apparatus according to the second embodiment. The flowchart is different from the flowchart of FIG. 7 according to the first embodiment in that the step S120 for determining whether the user is satisfied with the execution result is included.

### Step S120

The determination unit 107 inquires of the user whether the execution result is satisfied (whether the request sentence of the user is reflected), and the user determines whether the execution result is satisfied and inputs the determination result. This may be done by making an inquiry to the user on a chat interface where they input the request sentence and asking them to indicate whether they are satisfied with the execution result, or by displaying another window and asking them to input whether they are satisfied with the execution result.

When the user cannot obtain the desired output in the determination unit 107, a change of the request sentence is received. For this purpose, the request sentence is acquired again at the step S102, and the process workflow and the input data are generated again.

By pushing a regeneration button in the bottom area of the screen, the processing of the instruction generation unit 103 and the data generation unit 104 may be re-executed to generate new input data. In the case when the input data can be changed by the user's operation, it is desirable to return to the previous data as displayed below the input data in FIG. 13.

Some APIs are similar, and the user may be confused about which one to use. For example, “detect crack (detect abnormality (crack) from image)” and “detect rust (detect abnormality (rust) from image)” are APIs for detecting abnormality (crack, rust) from an image. It is considered that, when the user inputs a request to “detect an abnormality from a photograph of a machine in a factory and display the location of the abnormality”, two types of process workflows, “denoise image→detect_crack→visualize bbox” and “denoise image→detect rust→visualize bbox”, are generated as process workflows. The display control unit 106 searches for the same portion of the API execution sequence information of the plurality of process workflows. Any method may be used for this, and for example, a method of associating the same node with the greedy from the root, searching for a different node if any until the same node is found next, and repeating the same process can be used. Alternatively, an existing algorithm of the maximum common subgraph problem may be used. When the maximum common subgraph is found, the subgraph is removed and other next maximum common subgraph is searched for, and this process is repeated.

In this way, when a subgraph that does not match the graph is found, the size thereof is evaluated. When the ratio of the number of nodes of the subgraph that does not match the entire graph is equal to or greater than a predetermined threshold value, the API execution sequence information is determined not to be similar, and the display unit displays the API execution sequence information as another process workflow. When the ratio of the number of nodes of the subgraph that do not match is less than the threshold value, it is determined that the API execution sequence information is similar, and then the similarity of the subgraph that do not match is evaluated. Since the similarity between the subgraphs is not an evaluation of the similarity of the shapes of the graphs but an evaluation of the similarity of the processing purposes, the similarity determination may be performed using the scale of the similarity between the texts for the API descriptions connected to each other. For example, vector embedding is performed on each of two texts obtained by connecting descriptions, and the similarity between the texts can be measured by using cosine similarity. When the similarity between the subgraphs is equal to or higher than a predetermined threshold, the API execution sequence information is merged.

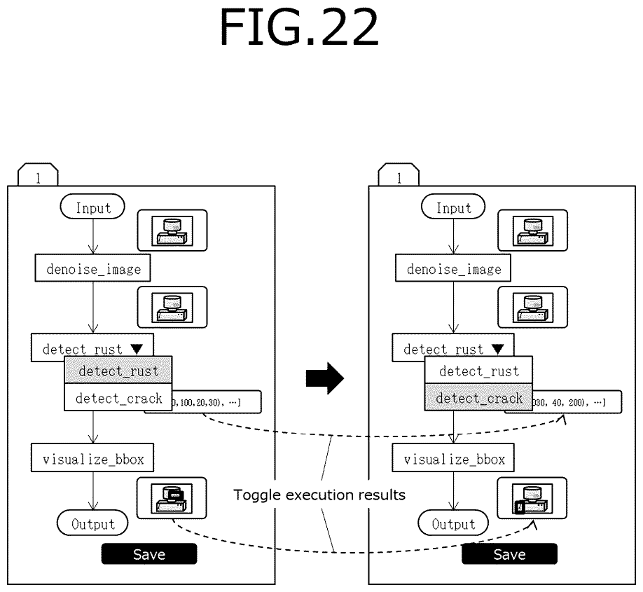

The API execution sequence information is merged by making the common subgraphs the same and making the non-matching subgraphs selectable. FIG. 22 is a schematic diagram illustrating an example of merging API execution sequence information of the information processing apparatus according to the second embodiment. The non-matching subgraphs can be selected by drop-down, and the display of the execution result of the process workflow is also switched according to the subgraph selected by the user. This makes it easier for the user to check a change in the execution result due to a difference in the selection of the API.

This flowchart is an example, and the process workflow is displayed at a time, but for example, the process workflow may be generated after it is determined whether or not the acquisition of the request is completed by an explicit input of the user. For example, the acquisition of the request may be ended when a instructional sentence such as “Generate a process workflow with this” is input to an input text box of the request sentence, or when “process workflow generation” button is prepared and the user pushes the button. Further, the input data may be regenerated after the change of the request by “regeneration” button or the like described in the display unit.

In addition, in a case when there are a plurality of input data sets, since it may take a lot of time to execute the process workflow for all the input data, the process workflow may be executed for one input data set first, and when the input data used in the display unit described above is switched, the process workflow may be executed for another input data set. Similarly, in a case when there are a plurality of process workflows, it may take a lot of time to execute the process workflows for all the process workflows, and thus the process workflows may be executed according to the display switching of the user.

As described above, in the present embodiment, since the input data and the application example according to the user's request and the use case are shown, it is easy to determine whether or not the input data can be actually used in the user's case. Further, since the user does not need to prepare the input data by himself/herself, the effect of the process workflow can be easily confirmed even when it is difficult to prepare the actual data. Further, since the input data is generated and displayed so that the difference between the plurality of generated process workflows can be easily confirmed, it is easy to select the final process workflow from the plurality of process workflows.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention, and are included in the invention described in the claims and the equivalent scope thereof.

What is claimed is:

1. An information processing apparatus comprising:
an acquisition unit configured to acquire a request,
a planning unit configured to generate one or more process workflows based on the request,
an instruction generation unit configured to generate one or a plurality of data generation instructions for the process workflow generated based on the request,
a data generation unit configured to select one input data generation method from a plurality of input data generation methods based on the data generation instruction, and generate input data,
an execution unit configured to execute the process workflow using the input data as input data and output an execution result, and
a display control unit configured to cause a display unit to display the input data, the execution result, and the process workflow in association with each other.

2. The information processing apparatus according to claim 1, wherein
the process workflow includes process flow information and a format of the input data.

3. The information processing apparatus according to claim 1, wherein
the planning unit is configured to generate a source code for generating the input data and is configured to generate the process workflow from the source code.

4. The information processing apparatus according to claim 1, wherein
the data generation instruction includes the input data generation method, and
the instruction generation unit is configured to select one or a plurality of the input data generation methods according to a format of the input data for each of the input data to be generated by the data generation unit and is configured to generate the input data by inputting the data generation instruction corresponding to the selected input data generation method to the data generation unit in accordance with the input data generation method.

5. The information processing apparatus according to claim 4, wherein
the input data generation method is executed by the data generation unit by determining whether to generate a plurality of input data or whether a relationship between a plurality of input data is independent or dependent in a ase when the plurality of input data is generated.

6. The information processing apparatus according to claim 1, wherein
the instruction generation unit is configured to generate the data generation instruction that enables determination of whether the request is reflected in the input data.

7. The information processing apparatus according to claim 1, further comprising:
a determination unit configured to determine whether the request is reflected in the input data.

8. The information processing apparatus according to claim 1, wherein
the display control unit is configured to switch between a display method capable of selecting and displaying a plurality of the process workflows and the corresponding execution results and a display method capable of selecting and displaying only one of the process workflows and the corresponding execution results, and display the selected process workflow and the corresponding execution result on the display unit.

9. The information processing apparatus according to claim 1, wherein
the execution unit is further configured to output an intermediate result during the period from executing the process workflow using the input data to outputting the execution result, and
the display control unit is configured to cause the display unit to display process flow information, the input data, the execution result, and the intermediate result, such that the process flow information corresponds to the intermediate result.

10. An information processing method using an information processing apparatus comprising:
acquiring a request,
generating one or more process workflows based on the request,
generate one or more data generation instructions based on the process workflow,
selecting one input data generation method from a plurality of input data generation methods based on the data generation instruction, and generating input data,
executing the process workflow using the input data as input data,
causing a display unit to display the input data, the execution result, and the process workflow in association with each other.

11. A computer-readable recording medium storing a program that causes an information processing apparatus to execute a process comprising:
acquiring a request,
generating one or more process workflows based on the request,
generating one or more data generation instructions based on the process workflow,
selecting one input data generation method from a plurality of input data generation methods based on the data generation instruction, and generating input data,
executing the process workflow using the input data as input data, and
causing a display unit to display the input data, the execution result, and the process workflow in association with each other.
